(19) United States
(12) Patent Application Publication
(10) Pub. No.: US 2005/0004845 A1
(43) Pub. Date: Jan. 6, 2005

(54) Print fulfillment with economical delivery quantities

(76) Inventor: Mark Vaughn, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/613,964

(22) Filed: Jul. 3, 2003

(51) Int. Cl. G06F 17/60

(52) U.S. Cl. 705/26

(57) ABSTRACT

Various systems, methods, and programs embodied in computer readable mediums are provided for print fulfillment. In one embodiment, a method is provided that comprises the step of maintaining a print quantity in a server. The print quantity maintained is associated with a recipient of printed images. The method also includes the step of accumulating a collection of images received from an originator in the server, where the collection of images is associated with the recipient. Also, the method further comprises the step of implementing a printing of the images included in the collection of images when a total number of the images included in the collection of images breaches the print quantity.

### BACKGROUND

The proliferation of imaging technologies such as digital cameras and the ever-growing reach of the Internet now makes it possible for individuals to take pictures that may be sent in digital form to a print vendor or other entity for print fulfillment. In this respect, the print vendors may employ sophisticated printing presses and printers to generate high quality images from the digital images provided by customers. Such printing may be of a quality that rivals traditional photo development using film and photographic paper. After images are printed by the print vendor, then they may be shipped to the customer. However, where customers may print small numbers of images at a time, the costs inherent in separately shipping each small group of images may deter individuals from using such printing services.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a block diagram of a print fulfillment system according to an embodiment of the present invention;

FIG. 2 is a schematic diagram of the print fulfillment system of FIG. 1 according to an embodiment of the present invention;

FIG. 3 is a flow chart of a print distribution system employed in the print fulfillment system of FIG. 2;

FIG. 4 is a flow chart of a vendor print system employed in the print fulfillment system of FIG. 2;

FIG. 5 is a block diagram of a print fulfillment system according to another embodiment of the present invention;

FIG. 6 is a schematic diagram of the print fulfillment system of FIG. 5 according to an embodiment of the present invention;

FIG. 7 is a flow chart of a print distribution system employed in the print fulfillment system of FIG. 6; and

FIG. 8 is a flow chart of a print execution system employed in the print fulfillment system of FIG. 6.

### DETAILED DESCRIPTION

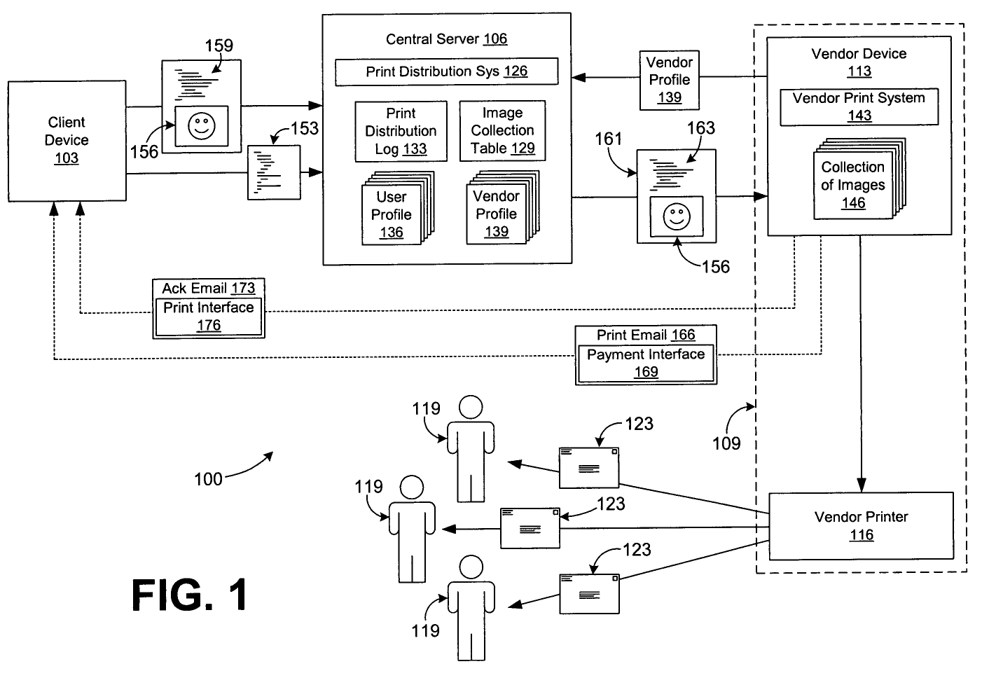

With reference to FIG. 1, shown is a block diagram of a print fulfillment system 100 according to an embodiment of the present invention. The print fulfillment system 100 includes a client device 103. The client device 103 may be, for example, a computer system, personal digital assistant, digital camera, scanner, or other device with like capability that is capable of coupling to a network such as, for example, the Internet in order to communicate with other devices.

The print fulfillment system 100 also includes a central server 106 and one or more print vendors 109. Each of the print vendors 109 may operate a vendor device 113 and one or more vendor printers 116. The central server 106 and the vendor device 113 may comprise, for example, computer systems or other devices with like capability. The client device 103, central server 106, and the vendor device 113 are coupled to a network that facilitates data communication between any two of such devices as will be discussed. The print fulfillment system 100 ultimately generates prints of images that are shipped to recipients 119 in shipments 123.

Executed on the central server 106 is a print distribution system 126 that controls the distribution of images for printing by print vendors 109 as will be discussed. In addition, the central server 106 also includes an image collection table 129 and a print distribution log 133. The image collection table 129 is employed by the print distribution system 126 to track the existence of collections of images within various vendor devices 113 as will be discussed. The print distribution log 133 is employed by the print distribution system 126 to track transmission of images to various print vendors 109 for print fulfillment as will be discussed.

The central server 106 also includes one or more user profiles 136 and one or more vendor profiles 139. Each of the user profiles 136 records the print preferences, payment information, a list of intended recipients of printed images, shipping information, and other information about a particular individual who generates or otherwise provides images to be printed. In this respect, such an individual is defined herein as an “originator” as they act as the origin of images to be printed as described herein. Each of the vendor profiles 139 describes the print capabilities and other information about a respective print vendor 109 that provides printing services as will be described herein.

The vendor device 113 includes a vendor print system 143 that is employed to accomplish the storage and printing of various collections of images 146. The vendor device 113 interfaces with the vendor printer 116 to accomplish the printing of the collection of images 146, thereby generating prints that are shipped as shipments 123 to an intended recipient 119. In this respect, each collection of images 146 stored therein is associated with a respective one of the recipients 119.

Next, a discussion of the operation of the print fulfillment system 100 is provided according to an embodiment of the present invention. To begin, an originator or other user manipulates the client device 103 to set up a printing account with the central server 106. In this respect, the originator enters and transmits user profile information 153 to the central server 106. In this respect, the user may manipulate a browser, for example, to access user interfaces or forms served up by the central server 106 and to enter the profile information 153 therein that is transmitted to the central server 106.

The profile information 153 may include, for example, an email address, a billing address, shipping preferences, and payment information such as a credit card number, bank account number, or other payment information. In addition, the profile information 153 may include a list of recipients 119 associated with the originator as well as a shipping address associated with each of the recipients 119. In this respect, the originator may also be one of the recipients 119 in that the originator would have a print vendor 109 generate prints of images for themselves. Alternatively, the originator may also wish to have prints of images sent to other recipients such as relatives and friends, etc. Also, for each of the recipients, the originator may specify a print quantity to be stored in the corresponding user profile 136. A user profile 136 may also specify preferred print vendors 109 selected by the originator for print fulfillment.

The vendor profiles 139 include information about the print capabilities of various print vendors 109. In this respect, the vendor profiles 139 may include a list of printers and/or printing presses that are employed by a specific print vendor 109 as well as print capabilities available to customers in terms of print size, print media types, and other capabilities. The vendor profiles 139 may also indicate minimum and maximum print quantities that can be handled by a respective print vendor 109 as well as methods of payment accepted by a print vendor 109. In addition, a vendor profile 139 may indicate the various shipping options that a print vendor 109 makes available to customers. A vendor profile 139 may also outline a fee schedule for various printing options or capabilities available to customers. To facilitate the entry and editing of vendor profiles 139, the central server 106 may make vendor profiles 139 available to print vendors 109, for example, over various networks such as the Internet.

The print fulfillment system 100 facilitates the printing of digital images generated or otherwise provided by the originator. In this respect, the central server 106 acts to route one or more images 156 uploaded from a client device 103 to a vendor device 113 of one of the print vendors 109. The central server 106 interacts with many different print vendors 109 and provides a communications bridge between the print vendors 109 and the originators. In addition, images are printed in predefined economical ship quantities that are then shipped to the intended recipient 119. To provide a clear explanation of the operation of the print fulfillment system 100, the operation is described with reference to a specific printing scenario.

The images may comprise, for example, digital photos or other types of documents. In this regard, such documents may comprise documents of all types generated by word processors or other devices. In this respect, the documents may include, but are not limited to, text documents, greeting cards, flyers, or any other type of document.

Assume, for example, that an originator wishes to employ the printing services that are provided by the print fulfillment system 100. To begin, the originator first sets up an account with the central server 106 by entering all necessary information to create a user profile 136. In this regard, the originator transmits the profile information 153 to the central server 106 that includes the information as described above. Thereafter, the user may generate or otherwise provide a number of images 156 that are transmitted in one or more allotments from the client device 103 to the central server 106 for print fulfillment. For example, the user may employ a client device 103 such as an Internet-capable digital camera to generate images 156 that are transmitted to the central server 106 for print fulfillment. Alternatively, the originator may generate pictures with a digital camera that are then downloaded to a computer system that acts as the client device 103 or the originator may generate images 156 using a word processor or in some other manner. Such a client device 103 may then be manipulated to upload the images to the central server 106.

The client device 103 also generates print instructions 159 that are associated with each image 156 or group of images 156 that are transmitted to the central server 106. The print instructions 159 may be embodied using any appropriate language such as, for example, Extensible Markup Language (XML) or other appropriate language. The print instructions 159 may specify, for example, each recipient 119 that is to receive a printed copy of the image and the number and size of one or more copies to be sent to each recipient 119. The print instructions 159 may also specify the quality of paper used for printing and other factors necessary for print fulfillment.

The originator may advantageously specify multiple recipients 119 of a copy of a single image. Assume, for example, that the images 156 are of a child of the originator who is involved in a particular sporting activity such as a baseball or soccer game. The originator may specify that the images 156 be printed and shipped to themselves as a first recipient, and that printed copies of select ones of the images 156 be shipped to the child's grandparent as a second recipient (who may live in another state or country), and so on. In addition, the print instructions 159 also include an identifier that associates the image(s) 156 with the respective originator.

In addition, the print instructions 159 may include an order for the immediate printing of the images 156 rather than a delayed printing of the images 156 upon reaching a predefined print quantity to ensure economical shipping quantities as will be discussed.

Upon receipt of each allotment of image(s) 156 and their associated print instructions 159 from the client device 103, the print distribution system 126 identifies all of the recipients 119 associated with a respective image 156 or group of images 156 and determines whether there is a pre-existing collection of images 146 for each of the specified recipients 119. The determination as to whether a collection of images 146 already exists for a respective recipient 119 may be made by examining whether a collection of images 146 is listed in the image collection table 129 for the recipient 119. If a collection of images 146 already exists, then the print distribution system 126 proceeds to generate a print submission 161 for each of the recipients 119 that includes the image(s) 156 along with appropriate print fulfillment instructions 163 to the vendor device 113 of the respective print vendor 109 that includes the pre-existing collection of images 146. The print fulfillment instructions 163 identify the respective collection of images 146 with which the one or more images 156 are to be associated.

Where two or more collections of images 146 exist for two or more recipients 119 who have been selected to receive the same images, then the separate print submissions 161 for each recipient 119 may include a reference to the same images 156 such as a filename or path, etc., rather than the images 156 themselves. In such case, the images 156 may be transmitted to the respective print vendor 109 separately or as part of one of the print submissions 161 to avoid sending multiple copies of the same image files over a network, etc.

However, if there is no pre-existing collection of images 146 for a respective recipient 119, then the print distribution system 126 uses the identifier included in the print instructions 159 to locate a respective one of the user profiles 136 that is associated with the originator. The print distribution system 126 then identifies if the originator has indicated a particular preference for a specific print vendor 109 that is to be used for print fulfillment.

In specifying preferences for print vendors 109, various options may be presented to the originator when they first create or subsequently edit their user profile 136. For example, the options may include a “vendor of the day” that offers to provide print services at reduced cost for a predefined period of time. The vendor of the day may be named by the operator of the central server 106 in conjunction with agreements made with specific print vendors 109, for example, to obtain preferred pricing for print services. Alternatively, the originator may specify a preference for one or more print vendors 109 as well as a priority among those selected. For example, a specific print vendor 109 may be selected as a top priority vendor by the originator unless such print vendor 109 is incapable of providing the requested print products. In such case, the next priority print vendor 109 may be selected and so on. Still further, the originator may specify “no preference” of print vendors 109, thereby leaving the choice of a print vendor 109 solely to the entity that operates the central server 109. In such case, the entity might distribute images for print fulfillment based upon previously arranged contractual relationships with specific print vendors 109, etc.

Once a particular print vendor 109 is identified for print fulfillment, then the print distribution system 126 generates a print submission 161 including appropriate print fulfillment instructions 163 that are associated with the one or more images 156 that are to be sent to the identified print vendor 109. The print fulfillment instructions 163 include, for example, instructions to create a new collection of images 146 and to associate a print quantity therewith, where the print quantity is associated with the respective recipient 119 in the user profile 136 of the originator. The print fulfillment instructions 163 also include the size of the prints to be printed, the number of prints of each image per recipient 119, the paper employed for printing, the type of process employed in creating the prints, the quality of the prints to be created, and/or other information necessary for the print vendor 109 to fulfill the printing of the images 156.

Thereafter, the print distribution system 126 proceeds to transmit print submission 161 the respective images 156 along with the print fulfillment instructions 163 to the identified print vendor 109 for print fulfillment. In addition, the print distribution system 126 records the existence of the new collection of images 146 in association with the respective recipient 119 in the image collection table 129 for future reference when additional images 156 are received for the respective recipient 119. Also, the print distribution system 126 records information relating to the printing of the images 156 and to which print vendor 109 such images 156 were sent. For example, the print distribution system 126 may track the total number of images transmitted to a print vendor 109 for printing in the print distribution log. Such information allows the operator of the central server 106 to exact a fee, for example, from the print vendors 109 for referral of images 156 thereto for printing, etc.

When the print vendor 109 receives the images 156 in the vendor device 113 from the central server 106, then the vendor print system 143 determines if a collection of images 146 exists for the images 156 for one or more specified recipients 119 as set forth in the associated print fulfillment instructions 163. If a collection of images 146 has already been established for one or more recipients 119, then the images 156 are included in the respective pre-existing collection of images 146. Where no collection of images 146 exists for one or more specified recipients 119, the vendor print system 143 establishes a new collection of images 146 for each recipient 119 and associates the respective images 156 therewith.

After establishing a new collection of images 146, images 156 that are subsequently received by the vendor print system 143 for the respective recipient 119 are added thereto. Also, when a new collection of images 146 is established, a print quantity is associated therewith. In this respect, the vendor print system 143 maintains the print quantity in association with a respective collection of images 146 and with the respective recipient 119. The print quantity is specified in the print fulfillment instructions 163 generated by the print distribution system 126 using the respective user profile 136 as described above.

Thus, the vendor print system 143 accumulates each collection of images 156 for each recipient 119 from images 156 that were received from the originator. Also, each collection of images 156 is associated with a corresponding one of the recipients 119. When new images 156 are added to an existing collection of images 146, the vendor print system 143 determines whether the total number of images 156 included therein is greater than or equal to the print quantity associated therewith. In this respect, the total number of images 156 includes the existing images 156 as well as the images 156 to be added thereto.

If the print quantity associated with any collection of images 156 for a specific recipient 119 is breached by the total number of images 156 therein, then a printing of the entire collection of images 156 is implemented. To implement a printing of a collection of images 156 that has been accumulated by the vendor print system 143, the vendor print system 143 may first obtain payment for the printing and shipping of the images 156. In one scenario, the payment information such as a credit card number may already have been included in the print fulfillment instructions 163 transmitted to the vendor print system 143 along with images 156 during the accumulation of the collection of images 146. Alternatively, the vendor print system 143 may transmit a print email 166 to the client device 103 that includes a payment interface 169 to facilitate the payment for the printing of the images 156. In this respect, the payment interface 169 may facilitate the transmission of a credit card number or other method of payment to the vendor print system 143 using a secure connection, etc. In addition, payment for the printing of the images 156 may be provided for in some other manner.

Once payment for the printing of images 156 is provided, then the vendor print system 143 proceeds with implementing the printing of the images 156. In this respect, the vendor print system 143 interfaces with the vendor printer 116 to print the images 156 in the respective collection of images 146. Thereafter, the printed collection of images 146 is shipped to the associated recipient 119 as one of the shipments 123. Due to the fact that the printing of images 156 occurs after the print quantities are reached for each recipient 119, the problem of shipping uneconomical quantities is addressed. Specifically, originators may accumulate collections of images 156 in economical shipment quantities before they are printed and shipped to a respective recipient 119. In this respect, the originator can receive prints of images while reducing shipping costs.

In addition, when new images 156 are received by the vendor print system 143, the vendor print system 143 may generate an acknowledgement email 173 or other communication that is transmitted to the email address associated with the originator. The email address may be associated, for example, with the client device 103 as shown or some other device. The acknowledgement email 173 informs the originator that the print vendor 109 has received prints that are stored in one or more collections of images 156 to be printed for one or more corresponding recipients 119. The acknowledgement email 173 may also inform the originator of the current total number of images 156 in each collection of images 146 associated with one or more recipients 119. The acknowledgement email 173 includes a print interface 176 that allows the originator to specify the immediate printing of the images 156 accumulated in one or more collections of images 156 for one or more recipients 119 rather than waiting for the print quantity of such collections of images 156 to be breached as described above. This provides a user with the advantage of being able to specify early printing of images 156 when they would be willing to pay for the shipment 123 even though it may not include an economical shipment quantity. Such may be the case, for example, when images 156 are desired quickly for various personal reasons.

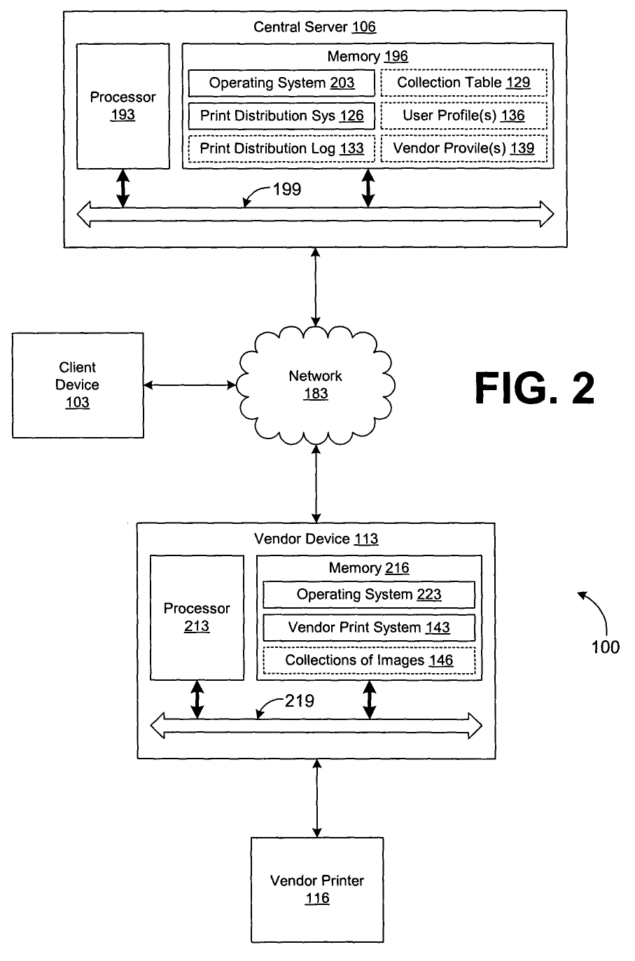

With reference to FIG. 2, shown is one embodiment of the print fulfillment system 100 according to the present invention. In this respect, the print fulfillment system 100 includes the client device 103, the central server 106, and the vendor device 113, all of which are coupled to a network 183. The network 183 may be, for example, the Internet, intranets, wide area networks (WANs), local area networks, wireless networks, or other suitable networks, etc., or any combination of two or more such networks. The network 183 facilitates data communication among the client device 103, the central server 106, the vendor device 113, and any other device coupled thereto.

The central server 106 includes a processor circuit having a processor 193 and a memory 196, both of which are coupled to a local interface 199. The local interface 199 may be, for example, a data bus with an accompanying control/address bus as can be appreciated by those with ordinary skill in the art. In this respect, the central server 106 may comprise, for example, a computer system or other device with like capability.

Stored in the memory 196 and executable by the processor 193 are an operating system 203 and the print distribution system 126. Also stored in the memory 196 and accessible by the processor 193 are the print distribution log 133, the collection table 129, the user profiles 136, and the vendor profiles 139. In this respect, when executed, the print distribution system 126 accesses data from and writes data to the print distribution log 133, the collection table 129, the user profiles 136, and the vendor profiles 139.

The vendor device 113 also includes a processor circuit having a processor 213 and a memory 216, both of which are coupled to a local interface 219. In this respect, the local interface 219 may be, for example, a data bus with an accompanying control/address bus as can be appreciated by those with ordinary skill in the art. Thus, the vendor device 113 may comprise, for example, a computer system or other device with like capability.

Stored in the memory 216 and executable by the processor 213 are an operating system 223 and the vendor print system 143. In addition, stored in the memory 216 are the collections of images 146 associated with corresponding recipients 119 (FIG. 1). The vendor device 113 is coupled to and interfaces with a vendor printer 116. In this respect, the vendor printer 116 may be any type of printer or printing press as can be appreciated by those with ordinary skill in the art.

The client device 103, central server 106, and the vendor device 113 may each include various peripheral devices as can be appreciated by those with ordinary skill in the art. In particular, such peripheral devices may include, for example, keyboards, keypads, touch pads, touch screens, microphones, scanners, a mouse, joysticks, or one or more push buttons, etc. The peripheral devices may also include display devices, indicator lights, speakers, printers, etc. Specific display devices may be, for example, cathode ray tubes (CRTs), liquid crystal display screens, gas plasma-based flat panel displays, or other types of display devices, etc.

A number of software components are stored in the memories 196 and 216 that are executable by the processors 193 and 213 as discussed above. In this respect, the term “executable” means a program file that is in a form that can ultimately be run by the processors 193 and 213. Examples of executable programs may be, for example, a compiled program that can be translated into machine code in a format that can be loaded into a random access portion of the memories 196 and 216 and run by the processors 193 and 213, or source code that may be expressed in proper format such as object code that is capable of being loaded into a of random access portion of the memories 196 and 216 and executed by the processors 193 and 213, etc. An executable program may be stored in any portion or component of the memories 196 and 216 including, for example, random access memory, read-only memory, a hard drive, compact disk (CD), floppy disk, or other memory components.

The memories 196 and 216 are each defined herein as both volatile and nonvolatile memory and data storage components. Volatile components are those that do not retain data values upon loss of power. Nonvolatile components are those that retain data upon a loss of power. Thus, each of the memories 196 and 216 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, each of the processors 193 and 213 may represent multiple processors and each of the memories 196 and 216 may represent multiple memories that operate in parallel processing circuits, respectively. In such a case, each of the local interfaces 199 and 219 may be an appropriate network that facilitates communication between any two of the multiple processors, between any processor and any of the memories, or between any two of the memories, etc. The processors 193 and 213 may be of electrical, optical, or molecular construction, or of some other construction as can be appreciated by those with ordinary skill in the art.

Also, the operating systems 203 and 223 are executed to control the allocation and usage of hardware resources such as the memory, processing time and peripheral devices in the central server 106 and the vendor device 113. In this manner, the operating systems 203 and 223 serve as the foundation on which applications depend as is generally known by those with ordinary skill in the art.

The client device 103 also may include a processor circuit having a processor and a memory similar to those discussed with respect to the central server 106 and the vendor device 113 above.

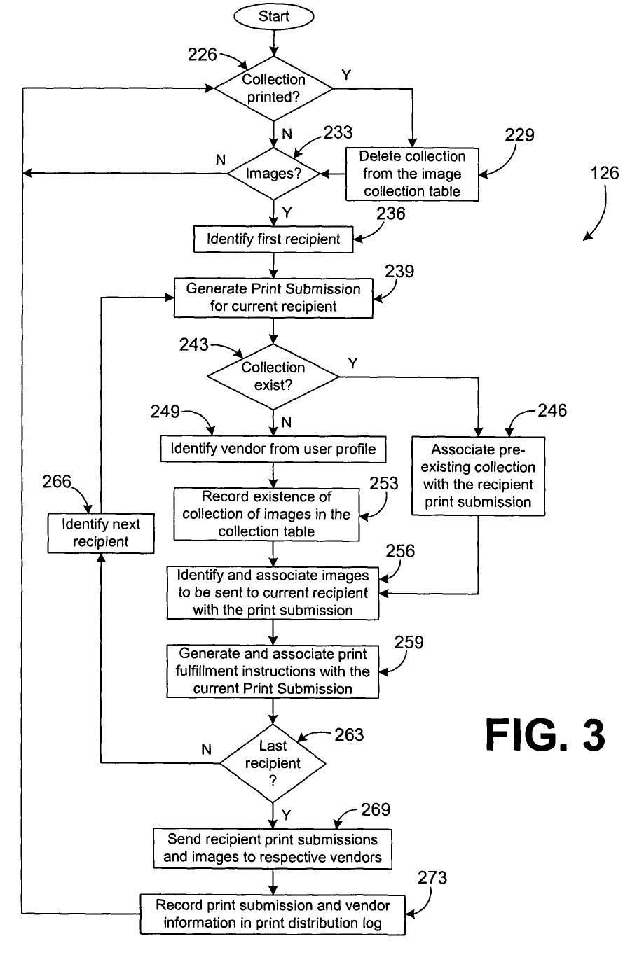

Referring next to FIG. 3, shown is a flow chart that provides one example of the operation of the print distribution system 126 according to an embodiment of the present invention. Alternatively, the flow chart of FIG. 3 may be viewed as depicting steps of an example method implemented in the central server 106 to distribute images among a number of print vendors 109 (FIG. 1) for print fulfillment in economic ship quantities. The functionality of the print distribution system 126 as depicted by the example flow chart of FIG. 3 may be implemented, for example, in an object oriented design or in some other programming architecture. Assuming the functionality is implemented in an object oriented design, then each block represents functionality that may be implemented in one or more methods that are encapsulated in one or more objects. The print distribution system 126 may be implemented using any one of a number of programming languages such as, for example, C, C++, JAVA, Perl, Python, Flash, or other programming languages.

Beginning with box 226 the print distribution system 126 determines whether a particular collection of images 146 stored by a printer vendor 109 have been printed either because a print quantity had been reached or an immediate order to print such images 156 was issued by the originator. This may be determined, for example, by receiving an appropriate message from the print vendor 109 indicating that such a collection of images 146 had been printed. Assuming that it is determined that a respective collection of images 146 has been printed, the print distribution system 126 then proceeds to box 229. Otherwise, the print distribution system 126 proceeds to box 233. In box 229 the respective collection of images 146 is deleted from the image collection table 129. Thereafter, the print distribution system proceeds to box 233.

In box 233, the print distribution system 126 determines if one or more images 156 (FIG. 1) have been received from one more client devices 103 (FIG. 1) to be distributed to appropriate print vendors 109 (FIG. 1) for print fulfillment. Assuming that images 156 have been received, the print distribution system 126 then proceeds to box 236. Otherwise, the print distribution system 126 reverts back to box 226. In box 236 the first recipient 119 (FIG. 1) of the one or more images received is identified. Thereafter, in box 239 the print distribution system 126 generates a print submission 161 (FIG. 1) in skeletal form that is to be associated with the currently identified recipient 119. Thereafter, in box 243, the print distribution system 126 determines whether a collection of images 146 (FIG. 1) exists for the currently identified recipient 119 within a vendor device 113 (FIG. 1) operated by a respective one of the vendors 109. If such is the case, then the images 156 destined for the current identified recipient 119 should be added to such a collection of images 146. Otherwise, a new collection of images 146 needs to be created by a predefined one of the vendors 109.

Assuming that a collection of images 146 already exists for the current identified recipient 119, the print distribution system 126 then proceeds to box 246. Otherwise, the print distribution system 126 progresses to box 249. Assuming that no collection of images 146 exists in box 243 and that the print distribution system 126 has proceeded to box 249, then the print distribution system 126 identifies an appropriate print vendor 109 for print fulfillment of the images 156 destined for the current identified recipient 119. This may be done, for example, by referring back to the user profile 136 associated with the originator as described above.

Once an appropriate printer vendor 109 has been identified in box 249, then the print distribution system 126 proceeds to box 253 in which the existence of the collection of images 146 that is to be newly created to accommodate the images 156 for the current identified recipient 119 is noted in the image collection table 129 (FIG. 1). Thereafter, in box 256, the print distribution system 126 identifies all images 156 to be sent to the currently identified recipient 119 that were received from a respective client device 103 and associates such images 156 with the current print submission 161.

Referring back to box 246, assuming that a collection of images 146 already exists for the currently identified recipient 119, the print distribution system 126 associates the pre-existing collection of images 146 associated with the currently identified recipient 119 with the current print submission. Thereafter, the print distribution system 126 proceeds to box 256 to associate the images 156 with the current print submission 161 as described above.

From box 256, the print distribution system 126 proceeds to box 259 where the appropriate print fulfillment instructions 163 (FIG. 1) are generated and associated with the current print submission 161. In this respect, unique print fulfillment instructions 163 may be associated with each of the images 156 that is in turn associated with the print submission 161. Alternatively, the same print fulfillment instructions 163 may be associated with two or more of the images 156 where appropriate. In any event, the print fulfillment instructions 163 provide the necessary information for the print vendor 109 to perform the tasks of print fulfillment as required by the originator. In this respect, the print fulfillment instructions 163 may comprise, for example, a print quantity of each of the images to be printed, the size of the images to be printed, the quality of the printing, the media upon which the images are to be printed, and other information as described above.

Next, in box 263, the print distribution system 126 determines whether the last recipient 119 associated with the number of images 156 received from the client device 103 has been processed. If not, then the print distribution system 126 proceeds to box 266. Otherwise, the print distribution system 126 moves to box 269. In box 266, the next recipient associated with the images 156 received from the client device 103 is identified. Thereafter, the print distribution system 126 reverts back to box 239.

Assuming that the print distribution system 126 proceeds to box 269, then the print distribution system 126 transmits each of the print submissions 161 to the respective print vendors 109. In this respect, each print submission 161 transmitted to each print vendor includes the print fulfillment instructions 163 and the images 156 associated therewith. Where the same images 156 may be associated with two or more print submissions 161 transmitted to the same print vendor 109, the actual images 156 may be transmitted along with one of the print submissions 161 or they may be separately transmitted. Where images are not transmitted as a portion of a respective print submission 161, such print submissions 161 may include a reference to such images 156 such as various filenames or paths, etc. In this manner, the duplicate transmission of images 156 that can be rather large in size is avoided.

Then, in box 273, data associated with the print submissions 169 and the print vendors 109 to which the print submissions 169 transmitted is recorded in the print distribution log 133. This data may be employed to determine commissions owed by print vendors 109 for the referral of images 156 for printing. Thereafter, the print distribution system 126 reverts back to box 226 as shown.

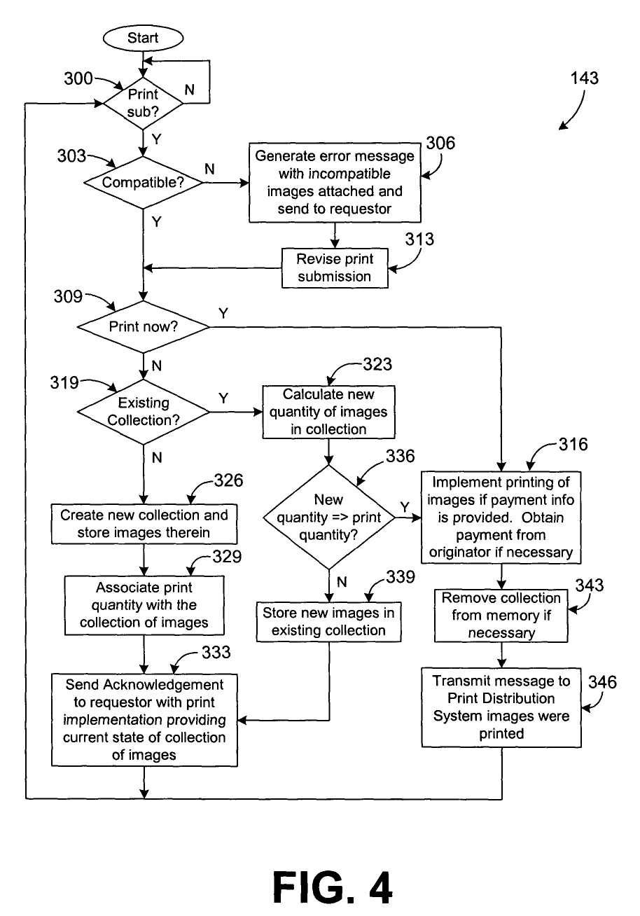

With reference to FIG. 4, shown is a flow chart that provides one example of the operation of the vendor print system 143 according to an embodiment of the present invention. Alternatively, the flow chart of FIG. 4 may be viewed as depicting steps of an example of a method implemented in the vendor device 113 (FIG. 2) to accomplish print fulfillment of images 156 (FIG. 1) in economic ship quantities. The functionality of the vendor print system 143 as depicted by the example flow chart of FIG. 4 may be implemented, for example, in an object oriented design or in some other programming architecture. Assuming the functionality is implemented in an object oriented design, then each block represents functionality that may be implemented in one or more methods that are encapsulated in one or more objects. The vendor print system 143 may be implemented using any one of a number of programming languages such as, for example, C, C++, JAVA, Perl, Python, Flash, or other programming languages.

Beginning with box 300, the vendor print system 143 waits until a print submission 161 (FIG. 1) is received from the central server 106. Assuming that a print submission 161 is received, then in box 303, the vendor print system 143 determines whether the current print submission 161 (FIG. 1) is compatible with the capabilities of the respective print vendor 109 (FIG. 1). In particular, the vendor print system 143 may detect that the requirements articulated in the print fulfillment instructions 163 (FIG. 1) with respect to one more images 156 (FIG. 1) are incompatible with the printing capabilities of one or more vendor printers 116 (FIG. 1). If the current print submission 161 is incompatible with the capabilities of the respective print vendor 109, then the vendor print system 143 proceeds to box 306. Otherwise, the vendor print system 143 moves to box 309.

In box 306, an error message is generated and transmitted to the central server 106 indicating such incompatibility. In addition, the vendor print system 143 may prompt the print vendor 109 to update the respective vendor profile 139 to prevent such incompatibilities from occurring in the future as the print distribution system 126 may select print vendors 109 based in part upon the capabilities expressed in the vendor profiles 139 and other factors as described above.

From box 306, the vendor print system 143 proceeds to box 313 in which the print submission 161 is revised so that the vendor print system 143 may proceed with print fulfillment for those images 156 and print fulfillment instructions 163 with which the print vendor 109 is compatible. Thereafter, the vendor print system 143 proceeds to box 309.

In box 309, the vendor print system 143 determines whether an order for immediate printing of the images 156 associated with a print submission 161 exists. In this respect, the print distribution system 126 may have included such an order as directed by the originator who submitted the images 156 for printing in the print fulfillment instructions 163 or may transmit such an order to the vendor print system 143 in response to the acknowledgement email 173 as discussed above. Assuming that an order for the immediate printing of the images 156 exists, then the vendor print system 143 proceeds to box 316. Otherwise, the vendor print system 143 proceeds to box 319.

In box 319, the vendor print system 143 determines whether a collection of images 146 already exists for the recipient 119 identified in the print submission 161 being processed. If such is the case, then the vendor print system 143 proceeds to box 323. Otherwise, the vendor print system 143 proceeds to box 326. In box 326, the vendor print system 143 creates a new collection of images 146 within which to store the images 156 to be printed for the recipient 119 associated with the print submission 161. Thereafter, in box 329, a print quantity identified in the print fulfillment instructions 163 is associated with the collection of images 146. In this respect, the print quantity is used to track when an economic ship quantity of images 156 exists in the collection of images 146 such that the collection of images 146 should be printed and shipped to the respective recipient 119.

Next, in box 333, the acknowledgement email 173 (FIG. 1) is generated and transmitted to the client device 103 (FIG. 1) or other device as designated by the email address supplied by the originator. The acknowledgement email 173 informs the originator that the new images 156 have been received to transmit to the respective recipient 119 and provides the latest total number of images 156 stored in the collection of images 146. Thereafter, the vendor print system 143 reverts back to box 300 to wait for the next print submission 161.

Referring back to box 323, assuming that an existing collection of images 146 has been identified for a current recipient 119 of the print submission 161 being processed in box 319, then the vendor print system 143 calculates a new total number of images 156 that would be included in the collection of images 146 once the images 156 associated with the print submission 161 are added thereto. Then, in box 336, if the new total number of images 156 calculated in box 323 is greater than or equal to the print quantity associated with the collection of images 146, then the vendor print system 143 proceeds to box 316. Otherwise, the vendor print system 143 proceeds to box 339.

In box 339, the vendor print system 143 adds the new images 156 received in association with the print submission 161 to the collection of images 146. In this respect, the collection of images 146 is accumulated over time as additional print submissions 161 are received with images 156 destined for the respective recipient 119. Thereafter, the vendor print system 143 proceeds to box 333 to generate and transmit the acknowledgement email 173 as described above.

Referring back to box 316, assuming that the vendor print system 143 detected an order for immediate printing in box 309 or that the vendor print system 143 determined in box 336 that the new total number of images 156 calculated in box 323 is greater than or equal to the print quantity associated with the respective collection of images 146, then the vendor print system 143 implements the printing of all images 156 destined for the recipient 119 provided that payment can be obtained by virtue of a credit card number or other account known to the vendor print system 143, etc. Alternatively, the vendor print system 143 may obtain payment from the originator by a transmitting the print email 166 (FIG. 1) or through some other approach. In order to implement the printing of the images 156, the vendor print system 143 may direct the printing of the images 156 on a respective vendor printer 116 (FIG. 1). Thereafter, the print vendor 109 may ship the printed images to the respective recipient 119 as one of the shipments 123 (FIG. 1).

In box 343, the vendor print system 143 removes the collection of images 146 from the memory 216 (FIG. 2) as may be necessary. For example, a collection of images 146 may not be stored in the memory 216 if new images 156 destined for a new recipient 119 are the subject of an order for immediate printing. Alternatively, the vendor print system 143 may store all images 146 temporarily that are to be printed for a respective recipient 119 until confirmation that all images 156 were successfully printed. In still another alternative, all images 156 may be stored in the memory 216 for a predefined period of time after the printing thereof to enable originators to print additional copies for various recipients 119 as they may desire.

Then, in box 346, the vendor print system 143 generates and transmits a message to the print distribution system 126 (FIG. 1) that informs the print distribution system 126 that images 146 destined for a particular recipient 119 were successfully printed. This is done so that the print distribution system 126 may remove the indication of the existence of the collection of images 146 from the image collection table 129. Thereafter, the vendor print system 143 reverts back to box 300 as shown.

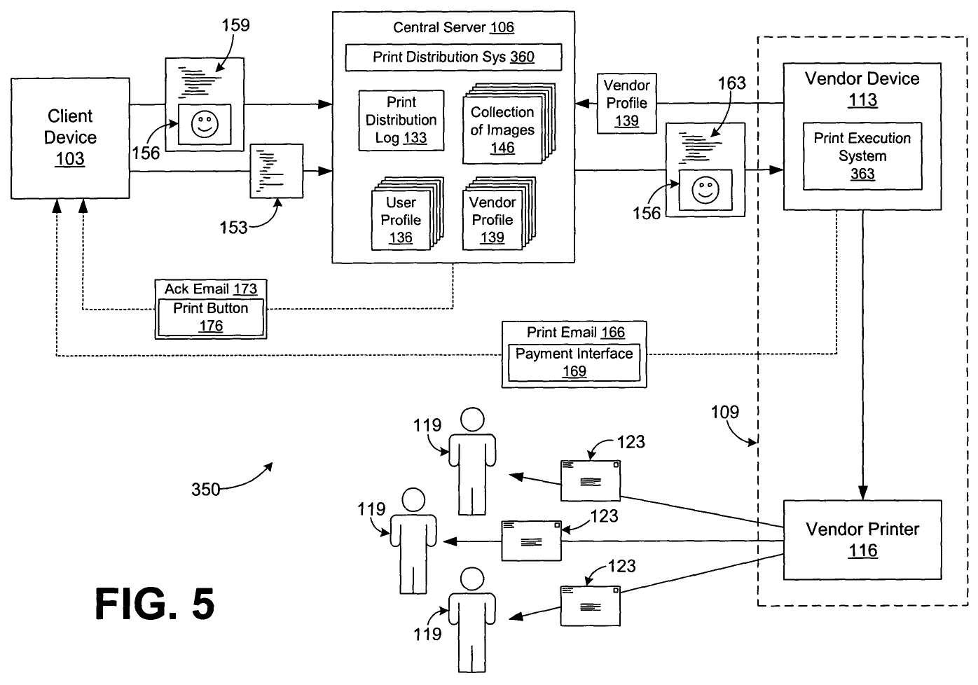

With reference to FIG. 5, is a block diagram of a print fulfillment system 350 according to another embodiment of the present invention. In this respect, the print fulfillment system 350 is similar to the print fulfillment system 100 (FIG. 1) with a few differences. For example, in the print fulfillment system 350, the collections of images 146 are stored in the central server 106. In this respect, the print fulfillment system 350 includes a print distribution system 360 that accumulates a collection of images 146 for each corresponding recipient 119 as images 156 are received from the client device 103.

To implement the printing of images 156 included in a respective collection of images 146 when the total number of images 156 included therein breaches a print quantity associated with the collection of images 146, the print distribution system 360 transmits each of the images 156 in the collection of images 146 to a selected print vendor 109 for printing. In this respect, the print distribution system 360 generates the print fulfillment instructions 163 that are transmitted with each of the images 156 to the print vendor 109. The print fulfillment instructions 163 include, for example, a ship address that is associated with the recipient 119 of the images 119 to facilitate the shipping of the printed ones of the images 156 to the respective recipient 119. The print fulfillment instructions 163 also include such other information as is needed for the print vendor 109 to successfully print out the images 156 as was described, for example, with reference to the print fulfillment system 100.

The print fulfillment system 350 also differs from the print fulfillment system 100 in that a print execution system 363 is executed on the vendor device 113. In this respect, the print execution system 363 is executed to automatically orchestrate the printing of the images 156 received from the central server 106 as directed by the print fulfillment instructions 163. The printing of the images 156 may occur at an appropriate time given the existing print load imposed upon the respective vendor printer 116 where images 156 may be temporarily stored in a print queue, etc. The print execution system 363 may also transmit the print email 166 with the payment interface 169 to the client device 103 or other device associated with the originator to obtain payment for the printing of the images 156.

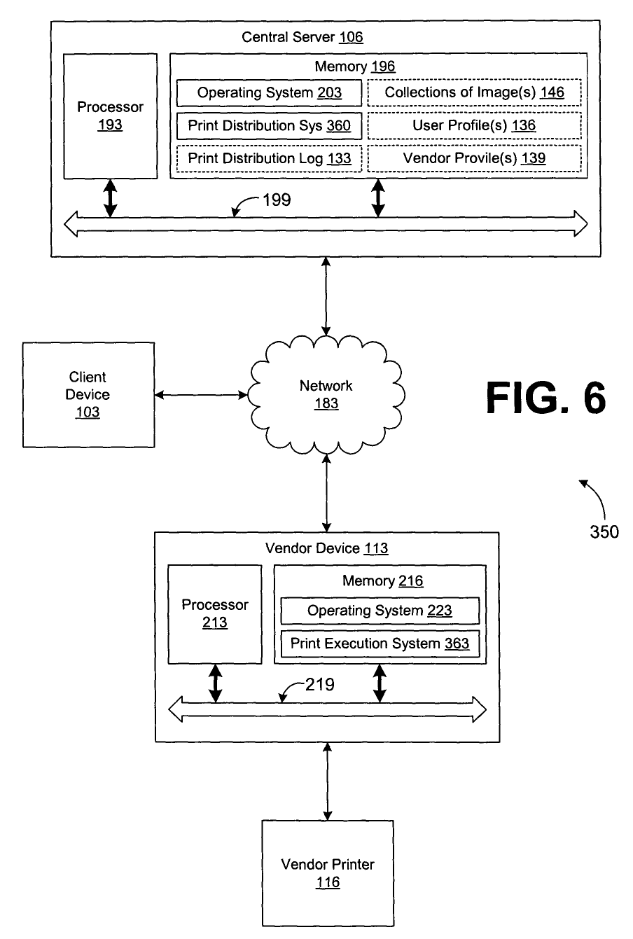

Referring next to FIG. 6, shown is one example embodiment of the print fulfillment system 350 according to the present invention. In this respect, the print fulfillment system 350 is similar to the print fulfillment system 100 as depicted in FIG. 6 with a few differences that are described herein. For example, stored in the memory 196 and executable by the processor 193 in the central server 106 is the print distribution system 360 along with the operating system 203. Also, stored in the memory 196 and accessed by the processor 193 in conjunction with the execution of the print distribution system 360 are the collections of images 146, the print distribution log 133, the user profiles 136, and the vendor profiles 139.

In addition, stored on the memory 216 and executable by the processor 213 is the print execution system 363 that is executed to automatically print images 156 received from the print distribution system 360 of the central server 106. Thus, the print fulfillment system 350 accumulates each collection of images 146 associated with corresponding recipients 119 (FIG. 5) in the central server 106 and transmits such images 156 to the vendor device 113 for printing when an economical ship quantity is obtained.

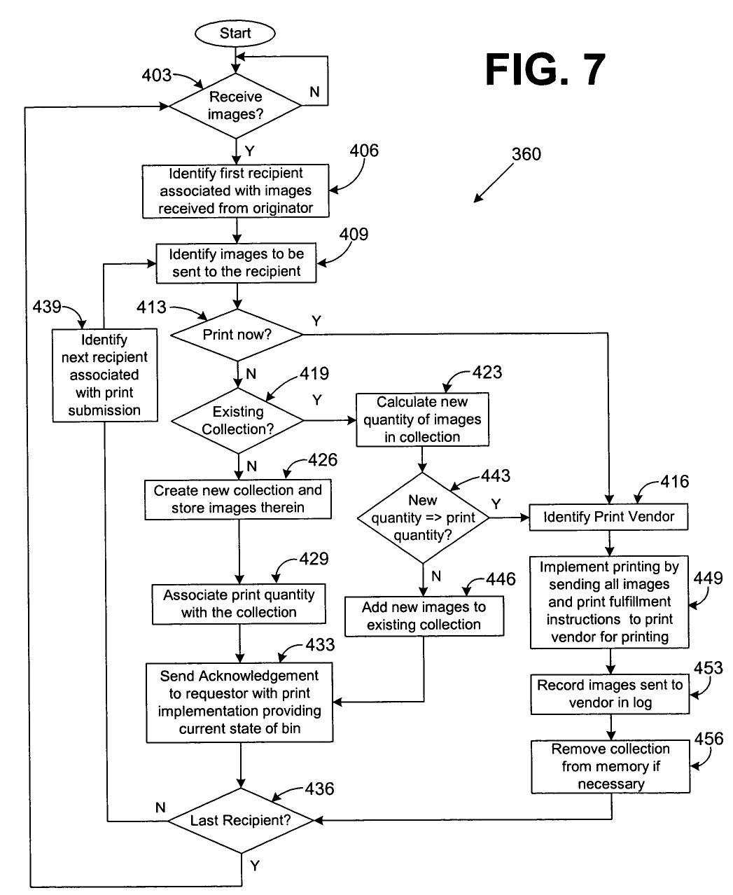

Referring next to FIG. 7, shown is a flow chart that provides one example of the operation of the print distribution system 360 according to an embodiment of the present invention. Alternatively, the flow chart of FIG. 3 may be viewed as depicting steps of an example method implemented in the central server 106 to accumulate images 156 (FIG. 5) that are distributed among a number of print vendors 109 (FIG. 5) for print fulfillment in economic ship quantities. The functionality of the print distribution system 360 as depicted by the example flow chart of FIG. 7 may be implemented, for example, in an object oriented design or in some other programming architecture. Assuming the functionality is implemented in an object oriented design, then each block represents functionality that may be implemented in one or more methods that are encapsulated in one or more objects. The print distribution system 360 may be implemented using any one of a number of programming languages such as, for example, C, C++, JAVA, Per[, Python, Flash, or other programming languages.

Beginning with box 403 the print distribution system 360 determines if one or more images 156 (FIG. 5) have been received from one more client devices 103 (FIG. 5) to be distributed to appropriate print vendors 109 (FIG. 5) for print fulfillment. Assuming that images 156 have been received, the print distribution system 360 then proceeds to box 406. In box 406 the first recipient 119 (FIG. 5) of the one or more images 156 received from the originator is identified. Thereafter, in box 409 the print distribution system 360 identifies all images 156 within the current allotment of images 156 received from the client device 103 that are to be sent to the currently identified recipient 119.

In box 413, the print distribution system 360 determines whether an order for immediate printing of the images 156 received from the client device 103 exists. In this respect, an order for the immediate printing of the images 156 may have been included in the print instructions 159 as directed by the originator. Assuming that an order for the immediate printing of the images 156 exists, then the print distribution system 360 proceeds to box 416. Otherwise, the print distribution system 360 progresses to box 419.

In box 419, the print distribution system 360 determines whether a collection of images 146 already exists, for example, in the memory 196 (FIG. 6) for the current designated recipient 119. If such is the case, then the print distribution system 360 proceeds to box 423. Otherwise, the print distribution system 360 proceeds to box 426. In box 426, the print distribution system 360 creates a new collection of images 146 in the memory 196 to store the images 156 to be printed for the current designated recipient 119. Thereafter, in box 429, a print quantity identified in the print instructions 159 or obtained from a corresponding user profile 136 (FIG. 5) is associated with the collection of images 146. In this respect, the print quantity is used to track when an economic ship quantity of images 156 exists in the collection of images 146 such that the collection of images 146 should be printed and shipped to the respective recipient 119.

Next, in box 433, the acknowledgement email 173 (FIG. 5) is generated and transmitted to the client device 103 (FIG. 5) or other device as designated by the email address supplied by the originator. The acknowledgement email 173 informs the originator that the new images 156 have been received to transmit to the respective recipient 119 and provides the latest total number of images 156 stored in the collection of images 146. The acknowledgement email 173 includes the print interface 176 that allows the originator to generate an order for the immediate printing of the collection of images 145 for the respective recipient 119. The receipt of such an order by the print distribution system 360 may cause the print distribution system 360 to implement printing of the images 156 beginning in box 416. Once the acknowledgement email 173 has been transmitted to the originator in box 433, then in box 436 the print distribution system 360 determines whether the last recipient 119 associated with the current allotment of images 156 received from the client device 103 has been considered. If not, then the print distribution system 360 proceeds to box 439. Otherwise, the print distribution system 360 reverts back to box 403 to wait for the allotment of images 156 to be received from the client device 103.

In box 439, the next recipient 119 associated with the current allotment of one or more images 156 received from the client device 103 is designated for consideration. Thereafter, the print distribution system 360 reverts back to box 409 as shown.

Referring back to box 423, assuming that an existing collection of images 146 has been identified for the current recipient 119 in box 319, then the print distribution system 360 calculates a new total number of images 156 that would be included in the collection of images 146 once the images 156 received from the client device 103 are added thereto. Then, in box 443, if the new total number of images 156 calculated in box 423 is greater than or equal to the print quantity associated with the collection of images 146 that is in turn associated with the current designated recipient 199, then the print distribution system 360 proceeds to box 416. Otherwise, the print distribution system 360 proceeds to box 446.

In box 446, the print distribution system 360 adds the new images 156 received from the client device 103 to the collection of images 146. In this respect, the collection of images 146 is accumulated over time as additional allotments of one or more images 156 are received that include images 156 destined for the respective recipient 119. Thereafter, the print distribution system 360 proceeds to box 433 to generate and transmit the acknowledgement email 173 as described above.

Referring back to box 416, assuming that the print distribution system 360 detected an order for immediate printing in box 413 or that the print distribution system 360 determined in box 443 that the new total number of images 156 calculated in box 423 is greater than or equal to the print quantity associated with the respective collection of images 146, then the print distribution system 360 identifies a print vendor 109 to print the images 156 for shipment to the current designated recipient 119. This may be done, for example, by consulting the user profile 136 associated with the originator to identify any preferences of print vendors 109 for one or more print vendors 109. Alternatively, the print distribution system 360 may make its own determination as to which print vendor 109 to which to send the images 156 for print fulfillment based upon predefined criteria, etc.

Once a print vendor 109 is identified for print fulfillment, then in box 449 the print distribution system 360 implements the printing of all images 156 destined for the current designated recipient 119 by generating print fulfillment instructions 163 that are associated with the images 156 and by transmitting such images 156 to the identified print vendor 109 for printing. In this respect, the print fulfillment instructions 163 may include a shipping address of the recipient 119, print size and number of copies of each image 156, print media to be employed for each image 156, payment information, and other information as is necessary. Note that the payment information may be obtained by virtue of a credit card number or other account known to the print distribution system 360 in the corresponding user profile 136 or received in the print instructions 159, etc. Alternatively, the print distribution system 360 may obtain payment from the originator by a transmitting the print email 166 (FIG. 5) or through some other approach.

Once the print vendor 109 receives the images 156 and accompanying print fulfillment instructions 163, the print execution system 363 (FIG. 5) orchestrates the printing of the images 156. Thereafter, the print vendor 109 may ship the printed images to the respective recipient 119 as one of the shipments 123 (FIG. 5).

Then, in box 453, data associated with the images 156 as well as the print vendor 109 to which the images 156 were transmitted is recorded in the print distribution log 133. This data may be employed to determine commissions owed by print vendors 109 for the referral of images 156 for printing. Next, in box 456 the print distribution system 360 removes the collection of images 146 from the memory 196 (FIG. 6) as may be necessary. For example, a collection of images 146 may not be stored in the memory 196 if new images 156 destined for a new recipient 119 are the subject of an order for immediate printing. Alternatively, the print distribution system 360 may store a collection of images 146 temporarily that are to be printed for a respective recipient 119 until confirmation that all images 156 were successfully printed. In still another alternative, all images 156 may be stored in the memory 196 for a predefined period of time after the printing thereof to enable originators to print additional copies for various recipients 119 as they may desire. Thereafter, the print distribution system 360 proceeds to box 436 to determine if the last recipient 119 has been processed with respect to the images 156 received from the client device 103 in box 403.

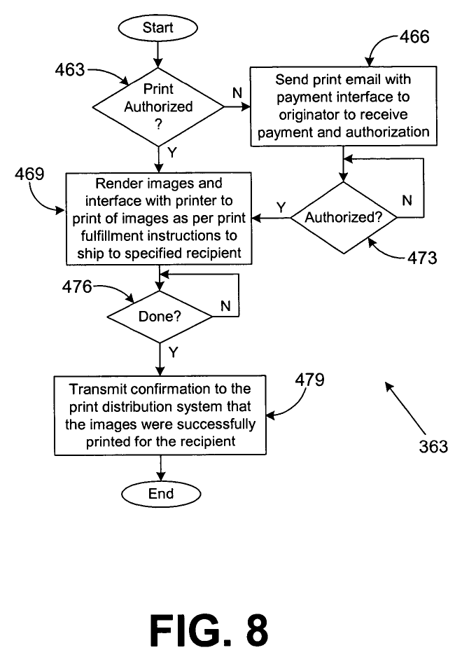

Referring next to FIG. 8, shown is a flow chart that provides one example of the operation of the print execution system 363 according to an embodiment of the present invention. Alternatively, the flow chart of FIG. 8 may be viewed as depicting steps of an example of a method implemented in the vendor device 113 (FIG. 6) to orchestrate the printing of images 156 (FIG. 5) received from the print distribution system 360 (FIG. 7). The functionality of the print execution system 363 as depicted by the example flow chart of FIG. 8 may be implemented, for example, in an object oriented design or in some other programming architecture. Assuming the functionality is implemented in an object oriented design, then each block represents functionality that may be implemented in one or more methods that are encapsulated in one or more objects. The print execution system 363 may be implemented using any one of a number of programming languages such as, for example, C, C++, JAVA, Perl, Python, Flash, or other programming languages.

Beginning with box 463, the print execution system 363 determines whether the printing of a collection of images 146 received from the print distribution system 360 is authorized. Such may be the case, for example, if payment is provided for the printing of the images 156 in the print fulfillment instructions 163 such as a credit card number or other account information, etc. If the printing is not authorized in box 463, then the print execution system 363 proceeds to box 466. Otherwise, the print execution system 363 progresses to box 469. In box 466, the print execution system 363 generates and transmits the print email 166 to the client device 103 or other device associated with the originator via the network 183 (FIG. 6). In this respect, the print email 166 includes the print interface 169 that facilitates user payment for the printing of the images 156 over the network 183.

Next, in box 473, the print execution system 363 waits to receive payment for the printing of the images 156. A timeout may be associated with the time period allotted to wait for a response from the originator after which printing of the images 156 may be canceled and an error sent back to the print distribution system 360.

Assuming that payment is received in box 473 thereby authorizing the printing of the images 156, then the print execution system 363 proceeds to box 469. In box 469 the print execution system 363 renders the images 156 into a format recognizable by a designated vendor printer 116 and interfaces with the designated vendor printer 116 to print the images 156 as specified in the print fulfillment instructions 163 associated with the images 156 for shipment to the respective recipient 109. Alternatively, the images 156 may be placed in an appropriate printing queue for rendering and printing, etc. Thereafter, in box 476, the print execution system 363 the print execution system 363 waits until printing of the images 156 is completed. Then, in box 479, the print execution system 363 generates and transmits confirmation to the print distribution system 360 that the images 156 were successfully printed for the respectfully recipient 119. Alternatively, such a message may also be generated and transmitted to the client device 103 or other device associated with the originator. Thereafter, the print execution system 363 ends.

Although the print distribution systems 126 (FIG. 3) and 360 (FIG. 7), the vendor print system 143, and the print execution system 363 are embodied in software or code executed by general purpose hardware as discussed above, as an alternative each may also be embodied in dedicated hardware or a combination of software/general purpose hardware and dedicated hardware. If embodied in dedicated hardware, the print distribution systems 126/360, the vendor print system 143, and the print execution system 363 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow charts of FIGS. 3, 4, 7, and 8 show the architecture, functionality, and operation of an implementation of the print distribution systems 126/360, the vendor print system 143, and the print execution system 363. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flow charts of FIGS. 3, 4, 7, and 8 show a specific order of execution, it is understood that the order of execution may differ from that which is depicted. For example, the order of execution of two or more blocks may be scrambled relative to the order shown. Also, two or more blocks shown in succession in FIGS. 3, 4, 7, and 8 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention.

Also, where the print distribution systems 126/360, the vendor print system 143, and the print execution system 363 comprises software or code, each can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the print distribution systems 126/360, the vendor print system 143, and the print execution system 363 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain embodiments, it is obvious that equivalents and modifications will occur to others skilled in the art upon the reading and understanding of the specification. The present invention includes all such equivalents and modifications, and is limited only by the scope of the claims.

1. A method for print fulfillment, comprising the steps of:
maintaining a print quantity in a server, the print quantity being associated with a recipient;
accumulating a collection of images received from an originator in the server, the collection of images being associated with the recipient; and
implementing a printing of the images included in the collection of images when a total number of the images included in the collection of images breaches the print quantity.

2. The method of claim 1, wherein the step of implementing the printing of the image included in the collection of images when the total number of the images included in the collection of images breaches the print quantity further comprises the steps of:
printing each of the images in the collection of images; and
shipping the images to the recipient.

3. The method of claim 1, wherein the step of implementing the printing of the images included in the collection of images when the total number of the images included in the collection of images breaches the print quantity further comprises the steps of:
transmitting each of the images in the collection of images to a print vendor for printing; and
transmitting a ship address associated with the recipient to the print vendor to facilitate shipping of printed ones of the image to the recipient.

4. The method of claim 3, further comprising the step of tracking a total number of the images transmitted to the print vendor for printing.

5. The method of claim 1, further comprising the step of implementing the printing of the images included in the collection of images upon receipt of an order for immediate printing of the collection of images from the originator.

6. The method of claim 1, wherein the step of accumulating the collection of images received from the originator in the server further comprises the steps of:
receiving a number of images from the originator;
adding each of the number of images to the collection of images; and
determining if the total number of the images included in the collection of images breaches the print quantity after adding each of the number of images to the collection of images.

7. The method of claim 1, further comprising the step of acknowledging a receipt of a number of images to the originator.

8. The method of claim 1, further comprising the step of sending a print notification to the originator when the total number of the images included in the collection of images breaches the print quantity.

9. The method of claim 1, further comprising the step of obtaining a payment for the implementation of the printing of the images included in the collection of images when the total number of the images included in the collection of images breaches the print quantity.

10. A system for print fulfillment, comprising:
a processor circuit having a processor and a memory;
an image printing system stored in the memory and executable by the processor, the image printing system further comprising:
a print quantity maintained in the memory, the print quantity being associated with a recipient;
logic that accumulates a collection of images in the memory, the images being received from an originator and the collection of images being associated with the recipient; and
logic that implements a printing of the images included in the collection of images when a total number of the images included in the collection of images breaches the print quantity.

11. The system of claim 10, wherein the logic that implements the printing of the images included in the collection of images when the total number of the images included in the collection of images breaches the print quantity further comprises logic that automatically interfaces with a printer to print each of the images in the collection of images for shipment to the recipient.

12. The system of claim 10, wherein the logic that implements the printing of the images included in the collection of images when the total number of the images included in the collection of images breaches the print quantity further comprises:
logic that automatically transmits each of the images in the collection of images to a print vendor for printing; and
logic that transmits a shipping address associated with the recipient to the print vendor to facilitate shipping of printed ones of the image to the recipient.

13. The system of claim 12, further comprising logic that tracks a total number of the images transmitted to the print vendor for printing.

14. The system of claim 10, further comprising logic that implements the printing of the images included in the collection of images upon receipt of an order for immediate printing of the collection of images from the originator.

15. The system of claim 10, wherein the logic that accumulates the collection of images in the memory further comprises:
logic that adds a number of the images received from the originator to the collection of images; and
logic that determines if the total number of the images included in the collection of images breaches the print quantity after adding each of the number of images to the collection of images.

16. The system of claim 10, further comprising logic that automatically transmits an acknowledgement of a receipt of a number of images to the originator.

17. The system of claim 10, further comprising logic that automatically transmits a print notification to the originator when the total number of the images included in the collection of images breaches the print quantity.

18. The system of claim 10, further comprising logic that transmits a payment interface to the originator to obtain a payment for the implementation of the printing of the images included in the collection of images when the total number of the images included in the collection of images breaches the print quantity.

19. A system for print fulfillment, comprising:
means for maintaining a print quantity associated with a recipient;
means for accumulating a collection of images received from an originator, the collection of images being associated with the recipient; and
means for implementing a printing of the images included in the collection of images when a total number of the images included in the collection of images breaches the print quantity.

20. The system of claim 19, wherein the means for implementing the printing of the images included in the collection of images when the total number of the images included in the collection of images breaches the print quantity further comprises means for automatically interfacing with a printer to print each of the images in the collection of images for shipment to the recipient.

21. The system of claim 19, wherein the means for implementing the printing of the images included in the collection of images when the total number of the images included in the collection of images breaches the print quantity further comprises:
means for automatically transmitting each of the images in the collection of images to a print vendor for printing; and
means for transmitting a shipping address associated with the recipient to the print vendor to facilitate shipping of printed ones of the image to the recipient.

22. A program embodied in a computer-readable medium for print fulfillment, comprising:
code that maintains a print quantity in a memory, the print quantity being associated with a recipient;
code that accumulates a collection of images in the memory, the images being received from an originator and the collection of images being associated with the recipient; and
code that implements a printing of the images included in the collection of images when a total number of the images included in the collection of images breaches the print quantity.

23. The program embodied in the computer-readable medium of claim 22, wherein the code that implements the printing of the images included in the collection of images when the total number of the images included in the collection of images breaches the print quantity further comprises code that automatically interfaces with a printer to print each of the images in the collection of images for shipment to the recipient.

24. The program embodied in the computer-readable medium of claim 22, wherein the code that implements the printing of the images included in the collection of images when the total number of the images included in the collection of images breaches the print quantity further comprises:
code that automatically transmits each of the images in the collection of images to a print vendor for printing; and
code that transmits a shipping address associated with the recipient to the print vendor to facilitate shipping of printed ones of the image to the recipient.

25. The program embodied in the computer-readable medium of claim 22, wherein the code that accumulates the collection of images in the memory further comprises:
code that adds a number of the images received from the originator to the collection of images; and
code that determines if the total number of the images included in the collection of images breaches the print quantity after adding each of the number of the images to the collection of images.
